(19) United States
(12) Patent Application Publication
(10) Pub. No.: US 2015/0018457 A1
(43) Pub. Date: Jan. 15, 2015

(54) USE OF LINEAR TRIETHYLENTETRAMINE AS CURING AGENT FOR EPOXY RESINS

(71) Applicant: BASF SE, Ludwigshafen (DE)

(72) Inventors: DOMINIC SUTER, Ludwigshafen (DE); Manfred Kinscherff, Romerberg (DE); Kirsten Dahmen, Freinsheim (DE); Hendrik Heising, Limburgerhof (DE); Achim Kaffee, Lorsch (DE); Johann-Peter Melder, Bohl-Iggelheim (DE); Boris Buschhaus, Mannheim (DE); Kevin Huyghe, Mannheim (DE); Gunther van Cauwenberge, Lokeren (BE)

(21) Appl. No.: 14/500,415

(22) Filed: Sep. 29, 2014

Related U.S. Application Data
(62) Division of application No. 13/039,109, filed on Mar. 2, 2011.
(60) Provisional application No. 61/309,461, filed on Mar. 2, 2010.

(51) Int. Cl. C08G 59/50; C08G 69/34

(52) U.S. Cl. CPC C08G 59/502; C08G 69/34
USPC 523/400; 525/523; 528/332; 252/182.13

(57) ABSTRACT

The present invention relates to an amine composition comprising linear triethylenetetramine and one or more amine compounds selected from the group consisting of tertiary amines derived from the condensation of ethylenediamine and methyl-substituted compounds derived from linear triethylenetetramine as well as a method of production for said composition.

The present invention also relates to the use of linear triethylenetetramine or an amine composition according to the invention as amine curing agents.

The present invention also relates to amine curing agent compositions comprising linear triethyienetetramine as well as to curable compositions comprising linear triethylenetetramine and to a method for producing said curable compositions.

Additionally, the present invention relates to a cured epoxy resin comprising linear triethylenetetramine, especially a reinforced composite, and a method for producing said cured epoxy resins.

Furthermore, the present invention relates to reactive polyamide resins obtainable from linear triethylenediamine and dimer fatty acids.

The present invention relates to an amine composition comprising linear triethylenetetramine and one or more amine compounds selected from the group consisting of tertiary amines derived from the condensation of ethylenediamine and methyl-substituted compounds derived from linear triethylenetetramine as well as a method of production for said composition.

The present invention also relates to the use of linear triethylenetetramine or an amine composition according to the invention as amine curing agents.

The present invention also relates to amine curing aoent compositions comprising linear triethylenetetramine as well as to curable compositions comprising linear triethylenetetramine and to a method for producina said curable compositions.

Additionally, the present invention relates to a cured epoxy resin comprising linear triethylenetetramine, especially a reinforced composite, and a method for producing said cured epoxy resins.

Furthermore, the presen invention relates to reactive polyamide resins obtainable from linear triethylenediamine and dimer fatty acids.

Curable compositions on the basis of amine curing agents and epoxy resins are used in the industry on a large scale to produce cured epoxy resins. Common applications include flooring, civil engineering, marine and industrial coatings, adhesives, tooling, composites, castings, composite lamination and encapsulations.

Epoxy resins are an important class of polymeric materials, characterized by the presence of more than one epoxy-ring. The epoxy resins are converted into cured epoxy resins, which are solid, infusible and insoluble 3-dimensional networks, with the help of curing agents, which can undergo chemical reactions with the epoxy rings of the epoxy resin.

Commonly amines are used as functional curing agents. These amines can be either primary or secondary amines. A primary amine group can react with two epoxy groups while a secondary amine can react only with one epoxy group. Usually, primary amine groups react much faster than secondary amine groups. Tertiary amines, which have no active hydrogen, will not react with the epoxy groups at all, but will generally act as a catalyst to accelerate the epoxy reaction.

The reactivity of amines depends also on their chemical nature. Aliphatic amines are generally more reactive than cycloaliphatic amines, which are in turn more reactive than aromatic amines. Aliphatic amines are therefore suitable for curing epoxy-resins at room temperature whereas aromatic amines generally require higher curing temperatures.

Aromatic amines are usually employed in applications requiring high temperature stability because they lead to final materials having a high glass transition temperature (T_{g}). Also aromatic amines result in materials having a good resistance to chemicals. The light stability of aromatic curing agents is on the other hand insufficient for some applications. Since many aromatic amines are solid at room temperatures and due to their lower reactivity, they usually require elevated temperature cures. In addition, the viscosity of the epoxy systems is higher than that of aliphatic or cycloaliphatic amines. Cycloaliphatic amines can result in materials having a T_{g} approaching those of aromatic amines.

An aliphatic amine composition which is widely used as curing agent for epoxy resins is commercially available triethylenetetramine (TETA). “Commercially available TETA” has been commonly produced by the reaction of ethylene dichloride with aqueous ammonia, which produces the hydrochloride salts of ethylenediamine and higher homologues. The reaction is usually carried out in the liquid phase without a catalyst. Treatment with caustic soda liberates the free amines. The process yields various derivatives of ethylenediamine (EDA), such as piperazine, diethylenetriamine, triethylenetetramine, tetraethylenepentamine, pentaethylenehexamine and aminoethylpiperazine, which are separated by distillation. However, distillation does not yield pure linear TETA, but a mixture of linear TETA with cyclic and branched compounds. The composition of “commercially available TETA” is specified, e.g. in the Screening Information Data Set of the Organization for Economic Co-Operation and Development (OECD SIDS) for “triethylenetetramine” (published by UNEP Publications; July 1998, available uder www.inchem.org/documents/sids/sids/112-24-3.pdf).

According to the above mentioned reference, the content of linear TETA of formula (I)

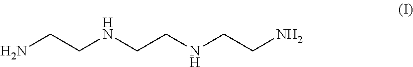

is between 60 to 70%.

Major impurities are:

N,N′-bis(2-aminoethyl)piperazine (DAEPIP): 11-13%;

(piperazinoethyl)ethylenediamine (PEEDA): 10-13%;

tris(aminoethyl)amine (TAEA): 4-6%;

diethylenetriamine (DETA): <=3%; and

water: <=0.5%.

Minor amounts of further side products, such as aminoethylethanolamine (AEEA), N-(2-aminoethyl)piperazine (AEPIP), hydroxyethylpyrrolidon (HEP) and tetraethylenepentamine (TEPA) may be also present.

DAEPIP (II), PEEDA (III) and TAEA (IV) are amine compounds comprising a tertiary amine group having the following formulas:

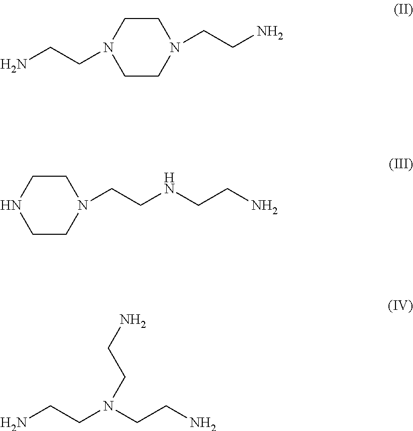 [SMILES: NCCN1CCN(CCN)CC1 ; NCCNCCN1CCNCC1 ; NCCN(CCN)CCN]

The use of the designation “triethylene tetramine” or “TETA” for the above mentioned mixture gives rise to some confusion, because the designation “triethylene tetramine” or “TETA” commonly used and known in the epoxy industry does not refer to the linear compound of formula I but to the commercially available mixture. In general, the linear compound of formula I is not commercially available in a purity higher than 70%. Therefore references made to “TETA” or “triethylene tetramine” in the literature relating to epoxy resins generally refer to the commercially available mixture and not to the linear compound of formula I.

“Pure TETA” or “purified TETA” having a purity higher than 98% was reported in US-A-2006/0041170 and in the above mentioned OECD SIDS. US-A-2006/0041170 describes the use of essentially pure TETA in pharmaceuticals. However these publications do not refer to the use of “pure” or “purified TETA” in epoxy applications.

In the context of the present invention the term “linear TETA” designates the compound of formula The term “commercially available TETA” refers to the industrially and commercially available product having a content of about 60 to 70% by weight of linear TETA as described above. Further, the terms “pure TETA” or “purified TETA” depict compositions comprising linear TETA having a content of linear TETA of 98% by weight or more.

As mentioned above, the use of “commercially available TETA” as a curing agent in epoxy resins is well established due to its high availability and is low price. “Commercially available TETA” shows good curing properties. These curing properties may be attributed to the presence of the tertiary amines which act as a catalyst in the reaction between primary and secondary amines with epoxides. A good curing behavior decreases the time in which form parts can be demolded leading to shorter production cycles, In addition, the use of “commercially available TETA” results in epoxy systems having a low brittleness. The setback of using “commercially available TETA” is the fact that due to the high content of tertiary amines, which can be present in an excess of 30% by weight and which do not participate in the curing reaction, only low network densities are achieved which results in epoxy resins having a low glass temperature of typically less than 120° C. Higher glass transition temperatures are often desirable because it broadens the temperature range in which form parts made of epoxy resin can be applied. For “commercially available TETA”, higher glass transition temperatures can generally not be achieved without sacrificino other properties, such as the curing properties characterized by the gel time, setting time, time of hardening or curing time or the handling properties characterized by the latency time or the pot life or the mechanical properties, e.g. the brittleness.

The curing time, gel time, setting time or time of hardening usually all refer to the time required for a resin to effectively solidify at the molding temperature. In the context of the present invention the term curing time will be used to denote this property. A reduced curing time enables a shorter demolding time or a quicker release of form parts from their molds which allows for shorter production cycles.

The latency time or the pot life usually both refer to the length of time that a resin system retains a viscosity low enough to be used in processing. In the context of the present invention the term pot life will be used to denote this property. A long pot life enables the filling of complicated forms to make complex form parts and ensures a high level of process stability.

For example, the addition of additional linear amines, such as ethylenediamine (EDA) would result in an increase of the glass transition temperature but would also lead to an increase in the curing time due to a dilution of tertiary amine components. Furthermore, the characteristic mechanical properties of “commercially available TETA” would be detrimentally affected by the substitution with other linear amines. In addition, lower amines, such as EDA, have a lower boiling point and therefore contribute to an undesired increase of volatile organic compounds (VOC).

The addition of cycloaliphatic or aromatic amines would also increase the glass transition temperature. But cycloaliphatic and aromatic amines are generally less readily available and significantly more costly than aliphatic amines. Therefore, the use of cycloaliphatic and aromatic amines would significantly decrease the economic viability of epoxy systems making them unattractive for large scale applications. Aromatic and cycloaliphatic amines generally have a higher viscosity which effects flowability and processing of the epoxy mixture. Aromatic or cycloaliphatic amines would also lead to an increase of the curing time because of their reduced reactivity. In addition, the use of aromatic amines decreases the light stability and leads to a discoloration of the resin.

The object of the present invention is to provide an aliphatic amine curing agent leading to cured epoxy resins having a higher glass transition temperature without an increase in curing time and a decrease of the pot life in order to attain excellent mechanical properties of resulting cured epoxy resins and superior processing properties of the curable compositions.

The problem of the present invention is solved by an amine composition comprising from 85 to 98% by weight of triethylenetetramine of formula I

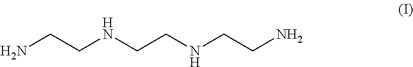

and 15% by weight or less of one or more amine compounds selected from the group consisting of tertiary amines derived from the condensation of ethylenediamine and methyl-substituted compounds derived from linear triethylenetetramine, based on the sum of the weight of TETA of formula I and the weight of the amine compounds selected from the group consisting of tertiary amines derived from the condensation of ethylenediamine and methyl-substituted compounds derived from linear triethylenetetramine.

The composition of the present invention comprises linear TETA of formula I, which is referred to as “linear TETA” as defined above.

The composition of the present invention also comprises one or more amine compounds selected from the group consisting of tertiary amines derived from the condensation of ethylenediamine and methyl-substituted compounds derived from linear triethylenetetramine.

In a preferred embodiment of the present invention the amine compound selected from the group consisting of tertiary amines derived from the condensation of ethylenediamine and methyl-substituted compounds derived from linear triethylenetetramine is a tertiary amine derived from the condensation of ethylenediamine.

Within the frame of the present invention “tertiary amines derived from the condensation of ethylenediamine” are termed “TADE”. The term “TADE” designates cyclic and branched derivatives of ethylenediamine (EDA) which may be considered to be built by the condensation of two or more EDA molecules and which have at least one tertiary amine oroup per molecule. The tertiary amines derived from the condensation of ethylenediamine usually have a degree of condensation of 2 or more, preferably 2 to 10, more preferably 2 to 6 and especially 2 to 4. Within the context of the present invention the degree of condensation refers to the number of EDA-molecules which condense to obtain the respective TADE.

TADE can be subdivided into cyclic tertiary amines which are derivatives of EDA (“cyclic TADE”) and branched tertiary amines which are derivatives of EDA (“branched TADE”).

Cyclic TADE can be characterized by general formula (V)

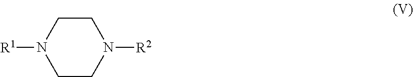

wherein R¹ is H and R² is CH₂CH₂X or

wherein R¹ and R² are both CH₂CH₂X;

wherein X═NR³₂,

and wherein R³ can be both or individually be H or CH₂CH₂X;

and wherein the degree of condensation is preferably 2 to 10, more preferably 2 to 6 and more preferably 2 to 4.

Cyclic TADE include but are not limited to bis(aminoethyl)piperazine (DAEPIP) (degree of condensation=4) of formula II and (piperazinoethyl)ethylenediamine (PEEDA) (degree of condensation=4) of formula III.

Branched TADE can be characterized by general formula (VI)

N(CH₂CH₂X)₃ (VI)

wherein X can be both or individually NR³₂;

and wherein R³ can be both or individually be H or CH₂CH₂X;

and wherein the degree of condensation is preferably 2 to 10, more preferably 2 to 6 and more preferably 2 to 4.

Branched TADE include but are not limited to

tris(aminoethyl)amine (TAEA) of formula IV (degree of condensation=3).

In another preferred embodiment of the present invention the amine compound selected from the group consisting of tertiary amines derived from the condensation of ethylenediamine and methyl-substituted compounds derived from linear triethylenetetramine is a methyl-substituted compound derived from linear triethylenetetramine.

In the context of the present invention, methyl-substituted compounds derived from linear triethylenetetramin are understood to mean any derivative of linear triethylenetetramine (linear TETA) in which one, two or more of the hydrogen atoms bonded to the four amino functions of the unsubstituted linear TETA are substituted by the corresponding number of methyl groups (CH₃—). In the following, these compounds will be subsumed under the term “Me-TETA”.

Me-TETA can be characterized by formula (VII)

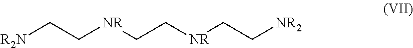

wherein R is either H or CH₃; with the proviso that at least one substituent R is CH₃.

Me-TETAs accordino to the present invention are shown by way of example in scheme 1 below as compounds (2) to (13).

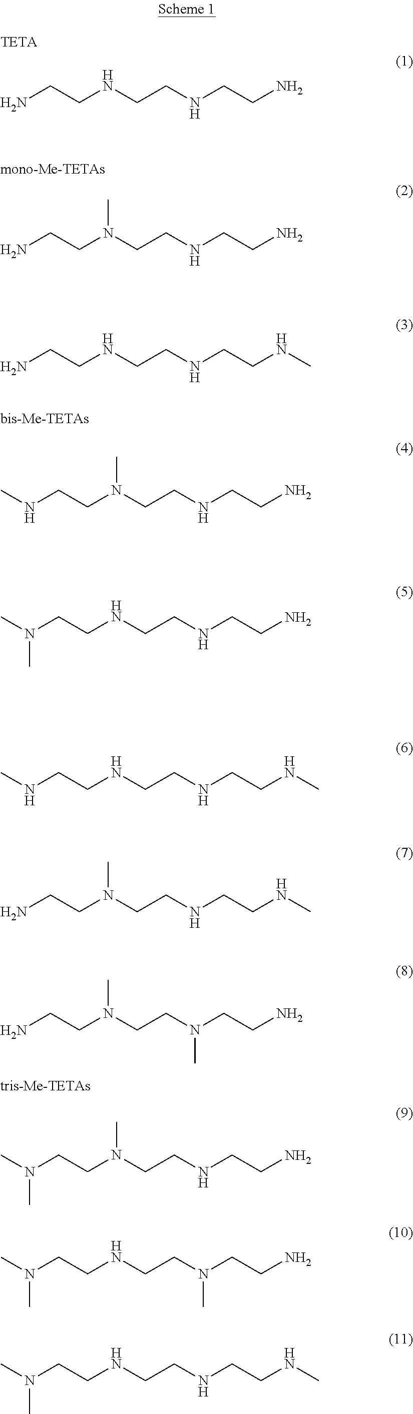

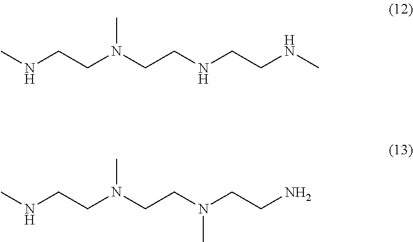

The methyl-substituted compounds derived from linear triethylenetetramine comprise Me-TETA with one (mono-Me-TETA; compounds 2 and 3), two (bis-Me-TETA; compounds 4 to 8) and three methyl substituents (tris-Me-TETA; compounds 9 to 13). In addition, the term Me-TETA also comprises Me-TETAs in which four, five or all six hydrogen atoms of the unsubstituted TETA are substituted by methyl groups (not shown in Scheme 1).

The methyl-substituted compounds derived from linear triethylenetetramine are preferably a mono-Me-TETA. More particularly, the methyl-substituted TETA compound is selected from N-2-aminoethyl-N′-(2-N″-methylaminoethyl)-1,2-ethanediamine (sec-MeTETA) and N-2-aminoethyl-N-methyl-N′-2-aminoethyl-1,2-ethanediamine (tert-MeTETA). sec-Me-TETA and tert-Me-TETA are depicted in scheme 1 as compounds 2 and 3 respectively.

The amine composition of the present invention comprises 85 to 98% by weight of linear TETA of formula I, based on the sum of the weight of TETA of formula I and the weight of the amine compounds selected from the group consisting of tertiary amines derived from the condensation of ethylenediamine and methyl-substituted compounds derived from linear triethylenetetramine, preferably 90 to 98% by weight, more preferably 92 to 98% by weight and especially 93 to 98% by weight.

The composition of the present invention may preferably also comprise 90 to 97% and more preferably 92 to 96% by weight of linear TETA of formula I, based on the sum of the weight of TETA of formula I and the weight of the amine compounds selected from the group consisting of tertiary amines derived from the condensation of ethylenediamine and methyl-substituted compounds derived from linear triethylenetetramine.

The composition of the present invention comprises 15% by weight or less of amine compounds selected from the group consisting of tertiary amines derived from the condensation of ethylenediamine and methyl-substituted compounds derived from linear triethylenetetramine, preferably 10% by weight or less, more preferably 8% by weight or less and especially 7% by weight or less, based on the sum of the weight of TETA of formula I and the weight of the amine compounds selected from the group consisting of tertiary amines derived from the condensation of ethylenediamine and methyl-substituted compounds derived from linear triethylenetetramine. The composition of the present invention may preferably also comprise 0.01 to 10%, 0.1 to 8% or 1 to 5% by weight of amine compounds selected from the oroup consisting of tertiary amines derived from the condensation of ethylenediamine and methyl-substituted compounds derived from linear triethylenetetramine, based on the sum of the weight of TETA of formula I and the weight of the amine compounds selected from the group consisting of tertiary amines derived from the condensation of ethylenediamine and methyl-substituted compounds derived from linear triethylenetetramine.

Preferably, the amine composition contains less than 5% by weight of bis(aminoethyl)-piperazine (DAEPIP), based on the sum of the weight of TETA of formula I and the weight of the amine compounds selected from the group consisting of tertiary amines derived from the condensation of ethylenediamine and methyl-substituted compounds derived from linear triethylenetetramine.

More preferably, it contains less than 2% by weight of DAEPIP, and particularly preferably it contains less than 1% by weight of DAEPIP, based on the sum of the weight of TETA of formula I and the weight of the amine compounds selected from the group consisting of tertiary amines derived from the condensation of ethylenediamine and methyl-substituted compounds derived from linear triethylenetetramine.

Preferably, the amine curing agent composition contains less than 5% by weight (piperazinoethyl)ethylenediamine (PEEDA), based on the total weight of the amine curing agent composition, More preferably, it contains less than 2% by weight of PEEDA, and particularly preferably it contains less than 1% by weight of PEEDA. Preferably, the amine curing agent composition contains less than 3% by weight of tris(aminoethyl)amine (TAEA), based on the sum of the weight of TETA of formula I and the weight of the amine compounds selected from the group consisting of tertiary amines derived from the condensation of ethylenediamine and methyl-substituted compounds derived from linear triethylenetetramine.

Particularly preferably, the amine curing agent composition contains less than 2% by weight of piperazine derivatives, such as DAEPIP and PEEDA. In particular, the overall content of piperazine derivatives is less than 1% by weight.

The amount of water and other organic side products is preferably less than 5% by weight, more preferably less than 2% by weight and most preferably less than 1% by weight, based on the sum of the weight of TETA of formula I and the weight of the amine compounds selected from the group consisting of tertiary amines derived from the condensation of ethylenediamine and methyl-substituted compounds derived from linear triethylenetetramine.

The content of linear TETA of formular and the second amine component selected from the group consisting of tertiary amines which are derivatives of ethylenediamine (TADE) and methyl-substituted TETA compounds (Me-TETA) can be determined using gas chromatography.

Amine compositions according to the present invention may be obtained by distillation of a reaction effluent obtained from the reaction of ethylene oxide with ammonia or by distillation of a reaction effluent obtained from catalytic hydrogenation of ethylenediaminediacetonitrile (EDDN).

The amine composition of the present invention can be advantageously obtained either as a top or as a side stream in the distillation of said reaction effluents.

In a preferred embodiment, amine compositions according to the present invention can be obtained by distillation of a reaction effluent obtained from the reaction of ethylene oxide with ammonia.

An overview of the reaction of ethylene oxide with ammonia is presented in the SRI-Report “CEH Product Review Ethylenamines”; SRI International, 2003, p. 7-8 and the PERP Report No. 138, “Alkyl-Amines”, SRI International 03/1981, pages 81 to 99 and page 117.

The reaction effluent of the reaction between ethylene oxide and ammonia usually contains ammonia, water, EDA, DETA, TETA and higher boiling amines (e.g. diethanolamine (DEOA), tetraethylenepentamin (TEPA), N-[1-(2-piperazine-1-yl-ethyl)]-ethane-1,2-diamine (C8-PIP)), piperazine and piperazine derivatives, especially AEPIP, as well as aminoethylethanolamine (AEEA). The reactor effluent is usually liberated from low boiling components such as ammonia and water, e.g. in the manner described in the above mentioned PERP Report.

The remaining products are usually introduced into another distillation column, in which a lower boiling mixture of EDA and piperazine is taken overhead. The column is usually operated at 1 bar.

The high boiling fraction is usually fed into a distillation column, which may be operated at 400 mbar, in which unreacted monethanolamine (MEOA) is removed at the head of the column.

The bottom product, which contains DETA, TETA, AEPIP and AEEA and higher boiling compounds is usually then fed to another column, which may be operated at 100 to 150 mbar, and in which DETA is taken overhead. The bottom product comprises TETA, AEPIP and AEEA as well as other higher boiling amines.

This mixture is generally fed into another distillation column where AEPIP is removed at the top of the distillation column, which is usually operated at a pressure of 1 to 50 mbar. Higher boiling amines, such as AEEA and TETA, are removed at the bottom.

In a subsequent stage, the bottom products comprising AEEA, TETA and higher boiling amines are fed into another distillation column, which may also be operated at a pressure of 1 to 50 mbar. AEEA is removed at the top of the column whereas TETA and higher boiling amines are obtained as a bottom product.

In a final distillation stage, the TETA composition according to the present invention is usually separated from higher boiling amines at a pressure of 1 to 50 mbar. The TETA composition according to the present invention can either be removed at the top of the column or as a side stream. If small amounts of AEEA are still present, it may be advantageous to remove the TETA composition as a side stream.

The detailed operating conditions of the respective distillation column may be routinely calculated and adapted by a person skilled in the arts taking into account the separating efficiency of the respective distillation column using the known vapour pressures and vapour pressure equilibria.

TETA compositions according to the present invention may be obtained by distillation of commercially available diethylenetriamine residues, which comprise AEEA, TETA and higher boiling amines, and which are obtained from the reaction of ethylene oxide with ammonia and subsequent distillation. Such diethylenetriamine residues are commercially available, e.g. as AMIX 1000, BASF SE. Amine compositions according to the present invention may be obtained by feeding commercially available diethylenetriamine residues into distillation column, which may also be operated at a pressure of 1 to 50 mbar. AEEA is removed at the top of the column whereas TETA and higher boiling amines are obtained as a bottom product. In a second distillation stage, the TETA composition according to the present invention is usually separated from higher boiling amines at a pressure of 1 to 50 mbar. The TETA composition according to the present invention can either be removed at the top of the column or as a side stream. If small amounts of AEEA are still present, it may be advantageous to remove the TETA composition as a side stream. The detailed operating conditions of the respective distillation columns may vary slightly depending on the exact composition of the diethyl enetriamine residues and may be routinely calculated and adapted by a person skilled in the arts taking into account the separating efficiency of the respective distillation column using the known vapour pressures and vapour pressure equilibria.

The amine composition obtained as a side stream usually has a content of linear TETA of 85 to 98% by weight, preferably 90% to 98% by weight and more preferably 93 to 98% by weight, based on the sum of the weight of TETA of formula I and the weight of the amine compounds selected from the group consisting of tertiary amines derived from the condensation of ethylenediamine and methyl-substituted compounds derived from linear triethylenetetramine.

The amine composition obtained as a side stream may also comprise 90 to 97% and more preferably 92 to 96% by weight of linear TETA of formula I, based on the sum of the weight of TETA of formula I and the weight of the amine compounds selected from the group consisting of tertiary amines derived from the condensation of ethylenediamine and methyl-substituted compounds derived from linear triethylenetetramine.

In addition, the amine composition comprises 15% by weight or less, more preferably 10% by weight or less and more preferably 8% by weight or less of tertiary amines derived from the condensation of ethylenediamine (TADE), based on the sum of the weight of TETA of formula I and the weight of the amine compounds selected from the group consisting of tertiary amines derived from the condensation of ethylenediamine and methyl-substituted compounds derived from linear triethyienetetramine.

The amine composition may preferably also comprise 0.01 to 10%, 0.1 to 8% or 1 to 5% by weight of tertiary amines derived from the condensation of ethylenediamine, based on the sum of the weight of TETA of formula I and the weight of the amine compounds selected from the group consisting of tertiary amines derived from the condensation of ethylenediamine and methyl-substituted compounds derived from linear triethylenetetramine.

In another preferred embodiment, the amine composition according to the present invention may also be obtained by rectification or distillation of a reaction effluent obtained from catalytic hydrogenation of ethylenediaminediacetonitrile (EDDN).

EDDN in turn is obtainable by reacting EDA with formaldehyde and hydrogen cyanide (HCN). The reaction of EDA with formaldehyde and hydrogen cyanide can be performed in different variants, for example by forming the formaldehyde cyanohydrin (FACH) intermediate, by first reacting formaldehyde and hydrogen cyanide in the absence of EDA. Reaction mixtures obtained from the hydrogenation of EDDN are disclosed in the examples of WO-A-2008104553. These reaction mixtures generally contain linear TETA, aminoethylpiperazine (AEPIP) and C4-components, such as diethylentriamine (DETA) and piperazine (PIP) as well solvent, e.g. THF. The content of TETA in the hydrogenation effluent according to the examples of WO-A-2008104553 is generally between 30 and less than 85% by weight.

In a preferred embodiment, the amine composition according to the present invention is obtained by freeing a reaction effluent obtained according to the examples of WO-A-2008104553 from solvents. Solvents, in particularly THF, can generally be removed by expanding the effluent to normal pressure and then feeding the effluent to a distillation column operated at normal pressure. THF is generally removed at the head of the column. If additional solvents are used, further distillation stages may be necessary.

The amine fraction obtained as the bottom product and which is essentially free of solvents is generally fed to another distillation stage,

In this distillation stage, which is preferably operated at 100 to 500 mbar, lower boiling components such as lower boiling side products and DETA are removed at the column head.

A mixture comprising AEPIP and TETA as well as other higher boiling amines is usually fed into another distillation column, which is preferably operated at 1 to 50 mbar, where AEPIP is usually removed at the top whereas TETA and higher boiling amines are removed at the bottom.

The bottom product from the previous distillation stage is usually further distilled in a subsequent distillation column also operated in a range of 1 to 50 mbar. A TETA composition according to the present invention is usually removed at the top of the column or as a side stream. Higher boiling amines are generally removed at the bottom of the column.

The detailed operating conditions of the respective distillation columns may be routinely calculated and adapted by a person skilled in the arts taking into account the separating efficiency of the respective distillation column using the known vapour pressures and vapour pressure equilibria.

The amine composition obtained as a side stream generally has a content of linear TETA of 85 to 98% by weight, preferably 90% to 98% by weight and more preferably 93 to 98% by weight, based on the sum of the weight of TETA of formula I and the weight of the amine compounds selected from the group consisting of tertiary amines derived from the condensation of ethylenediamine and methyl-substituted compounds derived from linear triethylenetetramine.

The amine composition obtained as a side stream may also comprise 90 to 97% and more preferably 92 to 96% by weight of linear TETA of formula based on the sum of the weight of TETA of formula I and the weight of the amine compounds selected from the group consisting of tertiary amines derived from the condensation of ethylenediamine and methyl-substituted compounds derived from linear triethylenetetramine.

In addition, the amine composition generally comprises 15% or less by weight of methyl-substituted TETA compounds (Me-TETA), more preferably 10% by weight or less of methyl-substituted TETA compounds (Me-TETA) and most preferably 8% by weight or less of methyl-substituted TETA compounds (Me-TETA).

The amine composition may also comprise 0.01 to 10%, 0.1 to 8% or 1 to 5% by weicht of methyl-substituted compounds derived from linear triethylenetetramine, based on the sum of the weight of TETA of formula I and the weight of the amine compounds selected from the group consisting of tertiary amines derived from the condensation of ethylenediamine and methyl-substituted compounds derived from linear triethylenetetramine.

Unexpectedly it hat been found that cured epoxy resins in which the amine compositions of the present invention are used as amine curing agents have a significantly higher glass transition temperature compared to epoxy resins obtained from “commercialiy available TETA”. In addition the curing time decreases while concurrently the pot life of the curable compositions comprising the amine composition according to the invention is lengthened. Furthermore, the characteristic mechanical properties attributed to “commercially available TETA” are maintained.

It has however also been discovered that the improvement of the properties in epoxy systems is not limited to the use of the amine composition of the present invention as amine curing agent but may also be extended to the use of “pure” or “purified TETA” having a content of linear TETA according to formula I of more than 98% by weight as an amine curing agent for epoxy applications. Such “pure” or “purified TETA” may be obtained according to a process described in US-A-2006/0041170. “Pure” or “purified TETA” may also be obtained by further purification of an amine composition according to the present invention or in analogy to the described methods for production of the amine composition of the present invention by adaptation of the distillation conditions and sequences described above for the production of the amine compositions according to the invention, e.g. by increasing the number of theoretical plated in the final distillation stage.

Therefore, the present invention also relates to the use of triethylenetetramine of formula I having a purity of 98% by weight or more and/or an amine composition according to the present invention as an amine curing agent.

In principle, the amine composition according to the present invention can be used as the sole amine curing agent or it can optionally be mixed other amine curing agents, such as the one described below, to form an amine curina agent composition. Likewise, “pure” or “purified TETA” having a content of linear TETA according to formula I of more than 98% by weight can be used as the sole amine curing agent or it can optionally be mixed other amine curing agents, such as the one described below, to form an amine curing agent composition.

The advantageous effects achieved by using TETA according to formula I of more than 98% by weight (“pure” or “purified TETA”) or the amine composition according to the present invention having a high content of linear TETA of formula I as compared to the prior art “commercially available TETA” will be less pronounced when diluted with other curing agents, but will still be present.

Therefore, the present invention also relates to an amine curing agent composition comprising an amine curing agent selected from the group consistina of an amine composition according to claim 1 and triethylenetetramine of formula I having a purity of 98% by weight or more, and one or more other amine curing agents.

Other amine curing agents are amine compounds having at least one or more, preferably two or more reactive amine hydrogen atoms in the molecule capable of reaction with an epoxy functionality.

Preferably, the other amine curing agents which may be used in combination with the amine curing agent selected from the group consisting of triethylenetetramine of formula having a purity of 98% by weight or more and an amine composition according to the present invention are:

heterocyclic amines, such as piperazine, N-aminoethylpiperazine;

cycloaliphatic amines, such as isophoron diamine, 1,2-(1,3; 1,4) -diaminocyclohexane, cyclohexylaminopropylamine (CHAPA), tricyclododecan diamine (TCD);

aromatic amines, such as the isomeric phenylenediamines, such as o-phenylenediamine, m-phenylenediamine, p-phenylenediamine, the isomeric tolylenediamines, such as 2,4-diaminotoluene and/or 2,6 diaminotoluene, the isomeric diaminonaphthalenes, such as 1,5-diaminonaphthalene, bis(4-aminophenyl)methane (MDA), the isomeric xylenediamines, such meta-xylenediamine (MXDA), bis(4-amino-3-methylphenyl)methane and bis(4-amino-3,5-dimethylphenyl)-methane; substituted aliphatic amines such as ethylene diamine, propylene diamine, hexamethylenediamine, 2,2,4 (2,4,4) etrimethylhexamethylene diamine, 2-methylpentamethylene diamine;

ether amines such as 1,7-diamino-4-oxaheptane, 1,10-diamino-4,7-dioxydecane, 1,14diamino-4,7,10-trioxatetradecane, 1,20-diamino-4,17-dioxyeicosan and in particular 1,12-diamino-4,9-dioxadodecane;

ether diamines based on propoxylated diols, triols and Polyols;

polyalkylene polyamines, such as dipropylene triamine, tripropylene tetramine;

as well as high molecular amines or addition or condensation products containing free amine hydrogen, in particular Mannich bases.

Most preferably, the other amine curing agent is isophoron diamine, 1,2-(1,3; 1,4)-diaminocyclohexane, cyclohexylaminopropylamine (CHAPA), tricyclododecan diamine (TCD), xylylene diamine, ethylene diamine, propylene diamine, hexamethylenediamine, 2,2,4 (2,4,4)-trimethylhexamethylene diamine, 2-methylpentamethylene diamine, 1,7-diamino-4-oxaheptane, 1,10-diamino-4,7-dioxydecane, 1,14-diamino-4,7,10-trioxatetradecane, 1,20-diamino-4,17-dioxyelcosan and 1,12-diamino-4,9-dioxadodecane

In an preferred embodiment, the content of amine curing agent selected from the group consisting of the amine composition according to the present invention and triethylenetetramine of formula I having a purity of 98% by weight or more being present in the amine curing agent composition according to the present invention is 25% by weight or more, preferably 50% by weight or more, more preferably 75% by weight and more and especially 90% by weight or more, based on the weight of the amine curing agent composition,

Within the context of the present invention, the weight of the amine curing agent composition is the sum of the weights of the amine curing agents selected from the group consisting of an amine composition according to the present invention and triethylenetetramine of formula I having a purity of 98% by weight or more and the other amine curing agents, as defined above, which are used in the production of epoxy resins.

In another preferred embodiment, the content of amine curing agent selected from the group consisting of the amine composition according to the present invention and triethylenetetramine of formula I having a purity of 98% by weight or more being present in the amine curing agent composition according to the present invention is from 25% to 99% by weight, preferably from 50% to 95% by weight and more preferably from 75% to 90% by weight, based on the weight of the amine curing agent composition.

The amine composition according to the present invention or triethylenetetramine of formula I having a purity of 98% by weight or more or the amine curing agent compositions accordina to the present invention can be mixed with epoxy resins to yield curable compositions.

Therefore, the present invention also relates to

curable composition comprising one or more epoxy resins and

an amine curing agent composition according to claims 4 to 6

or at least one amine curing agent selected from the group consisting of an amine composition according to claim 1 and triethylenetetramine of formula I having a purity of 98% by weight or more,

wherein the weight ratio of triethylenetetramine of formula I to amine compounds selected from the group consisting of tertiary amines derived from the condensation of ethylenediamine and methyl-substituted compounds derived from linear triethylenetetramine is 85:15 or more.

In a preferred embodiment, the curable compositions according to the present invention comprise triethylenetetramine of formula I having a purity of 98% by weight or more or the amine curing agent compositions according to the present invention as the sole amine curing agent.

In a further preferred embodiment, the the curable compositions according to the present invention comprise the amine curing agent compositions according to the present invention.

In addition to an amine curing agents and amine curing agent compositions according to the present invention, the curable composition also comprises one or more epoxy resins.

Epoxy resins are an important class of polymeric materials, characterized by the presence of more than one epoxy-ring.

A substantial enumeration of epoxy resins suitable for curable compositions can be found in the handbook “Epoxidverbindungen und Epoxidharze” of A. M. Paquin, Springer Verlag Berlin, 1958, Chapter IV; in Lee & Neville, “Handbook of Epoxy Resins”, 1967, Chapter 2; in Ullmann's Encyclopedia of industrial Chemistry, Wiley VCH Verlag GmbH, Electronic Edition 2005, Chapter “Epoxy Resins” and in “Epoxy Resins, Chemistry and Technology”, of C. A. May, Marcel Dekker Inc, New York, 1988, Chapter 2.

Commercially important epoxy resins are in particularly prepared by the coupling reaction of compounds containing at least two active hydrogen atoms with epichlorohydrin followed by dehydrohalogenation. Compounds which contain at least two active hydrogen atoms include polyphenolic compounds, mono and diamines, amino phenols, heterocyclic imides and amides, aliphatic diols and polyols, and dimeric fatty acids.

Epoxy resins derived from epichlorohydrin are termed glycidyl-based resins. Alternatively, epoxy resins based on epoxidized aliphatic or cycloaliphatic dienes are produced by direct epoxidation of olefins by peracids.

Epoxy resins also comprise reaction products of epichiorohydrin and bisphenol A. These products are generally termed DGEBA (Diglycidyl ether of bisphenol A). DGEBA where the degree of polymerization, n, is very low (n≅0.2) is typically referred to as liquid epoxy resin (LER) whereas high molecular weight (M_{W}) epoxy resins based on DGEBA characterized by a repeat unit containing a secondary hydroxyl group with degrees of polymerization, i.e., n values ranging from 2 to about 35 are generally denoted as solid epoxy resins (SER).

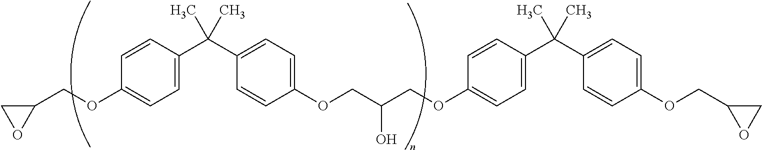

Epoxy resins also comprise so called epoxy novolac resins. The multifunctionality of these resins provides higher cross-linking density, leading to improved thermal and chemical resistance properties over bisphenol A epoxides. Epoxy novolacs are multi-functional epoxides based on phenolic formaldehyde novolacs. Both epoxy phenol novolac resins (EPN) and epoxy cresol novolac resins (EON) have attained commercial importance. The former is made by epoxidation of the phenol-formaldehyde condensates (novolacs) obtained from acid-catalyzed condensation of phenol and formaldehyde.

The epoxy compounds which can be used for the curable compositions and the cured epoxy resins derived therefrom are those resins described above or mentioned in the cited literature, in particular commercial products having more than one epoxy group per molecule on average, which are derived from monovalent and/or multivalent and/or multinuclear phenols, in particular bisphenols as well as novolacs, such as bisphenol-A and bisphenol-F-diglycidylether.

The epoxy resins preferably comprise epoxy resins selected from the group of bisphenol A bisglycidyl ether (DGEBA), bisphenol F bisglycidyl ether, bisphenol S bisglycidyl ether (DGEBS), tetraglycidylmethyienedianilines (TGMDA), epoxy novolacs (the reaction products of epichlorohydrin and phenolic resins (novolak)), and cycloaliphatic epoxy resins such as 3,4-epoxycyclohexylmethyl 3,4-epoxycyclohexanecar)oxylate and diglycidyl hexahydrophthalate.

Compositions of two or more epoxy resins may be used as well.

The curable compositions may comprise further additives such as additives common in epoxy resin technique. To be noted are, for example, gravels, sands, silicates, graphite, silica, talc, mica etc. in the particle size distributions as common used in this area. Suitable additives comprise e.g. antioxidants, UV absorbers/light stabilizers, metal deactivators, antistatic agents, reinforcing agents, fillers, biocides, lubricants, emulsifiers, colorants, pigments, rheology additives, mold release agents, catalysts or accelerators, flow-control agents, optical brighteners, flame retardants, antidripping agents and blowing agents.

An overview of additives, adjuvants and curing agents, which may be used in curable compositions is given in Ullmann's Encyclopedia of Industrial Chemistry, Wiley VCH Verlag GmbH, Electronic Edition 2005. Chapter “Epoxy Resins”, in “Epoxy Resins, Chemistry and Technology”, of C. A. May, Marcel Dekker Inc, New York, 1988, Chapter 3 and in “Epoxy Resins, Curing Agents, Compounds and Modifiers” by E. Flick, Noyes Publications, Park Ridge, 1987.

The weight ratio of epoxy resins and the amine curing agent compositions as well as additives and adjuvants may be varied to achieve and refine the desired application properties of the final cured epoxy and can be routinely determined by a person skilled in the art, e.g. the amine curing agent may be contained in the composition in such an amount that a molar ratio of epoxy groups of the epoxy resin to active hydrogen atoms of the amine curing agent ranges from 0.7 to 1.1, preferably from 0.8 to 1.0.

Irrespective of whether the curable composition according to the present invention comprises an amine curing agent composition according to claims 4 to 6 or at least one amine curing agent selected from the group consisting of an amine composition according to claim 1 and triethylenetetramine of formula I having a purity of 98% by weight or more, the curable compositions according to the present invention are characterized in that the weight ratio of linear triethylenetetramine of formula I to amine compounds selected from the group consisting of tertiary amines derived from the condensation of ethylenediamine and methyl-substituted compounds derived from linear triethylenetetramine is 85:15 or more, preferably 92:8 or more and more preferably 93:7 or more. The weight ratio of linear triethylenetetramine of formula I to amine cornpounds selected from the group consisting of tertiary amines derived from the condensation of ethylenediamine and a methyl-substituted compound derived from linear triethylenetetramine is also preferably from 85:15 to 99:1, more preferably from 90:10 to 98:2 and especially from 92:8 to 97:3.

In a preferred embodiment, the weight ratio of linear triethylenetetramine of formula I to amine compounds selected from the group consisting of tertiary amines derived from the condensation of ethylenediamine and a methyl-substituted compound derived from linear triethylenetetramine, is 98:2 or more. Such a curable composition may be obtained by using “purified TETA” as the sole amine curing &lent or by mixing “purified TETA” and other amine curing agents.

The present invention also relates to a

method for the production of a curable composition according to claim 7 by mixing an amine curing agent composition according to claims 4 to 6

or at least one amine curing agent selected from the group consisting of an amine composition according to claim 1 and triethylenetetramine of formula I having a purity of 98% by weight or more,

with at least one epoxy resin.

The process of mixing amine curing agents with one or more epoxy resins is well known to a person skilled in the arts, Generally mixing is effected by a mixing apparatus. The mixing apparatus can be of any type that can produce a highly homogeneous mixture of the epoxy resin and amine curing agent composition (and any optional components that are also mixed in at this time). Mechanical mixers and stirrers of various types may be used. Two preferred types of mixers are static mixers and impingement mixers. Mixing can be conducted batch-wise, semi-continuously or in a continuous fashion.

The epoxy resin and amine curing agent are generally separately heated to above room temperature prior to mixing them together, so that a curable composition is formed immediately upon mixing them. The epoxy resin and amine curing agent may each be heated to a temperature of 25° C., preferably 50° C., more preferably 80° C., or higher prior to mixing.

Other additives, such as the ones mentioned above, may be mixed with the amine curing agent or the epoxy resins prior to mixing the amine curing agent with the epoxy resin. It is also possible to mix other additives with the curable composition at the same time the amine curing agent and the epoxy resin are mixed, or afterwards.

After mixing, the thus obtained curable composition is typically transferred to a suitable mold (structural applications) or applied to a surface (coating applications), e.g. by spraying the curable composition on a surface, to obtain a cured epoxy resin.

Accordingly, the present invention further relates to a method of producing a cured epoxy resin by transferring the curable compositions according to the present invention to a mold or applying said curable compositions to a surface.

Appropriate processing technologies are known to a person skilled in the art and can be found e.g. in B. Ellis, “Chemistry and Technology of Epoxy Resins”, Kluwer Academic Publishers (February 1993).

Generally, the cured epoxy resins are obtained by allowing the curable composition to set after mixing and transfer to a mold or after application to a surface. During setting, the amine curing agents undergo a reaction with the epoxy resins present in the curable composition.

In a preferable embodiment of the invention, mixing and transfer of the curable composition is performed in one step, e.g. by reaction injection molding. The epoxy resin and amine curing agent composition (and optionally other components which are mixed in at this time) are pumped under pressure into a mixing head where they are rapidly mixed together. Operating pressures in high pressure machines may typically range from 7 to 14 MPa, although operation at lower pressures is also possible. The resulting curable composition is then preferably passed through a static mixing device to provide further additional mixing, and then transferred into the mold cavity.

In other embodiments, the curable composition is prepared by mixing as described before, and then applied to a surface, in particular by spraying the curable compositeon into a mold.

The mold is typically a metal mold, but it may be ceramic or a polymer composite, provided that the mold is capable of withstanding the pressure and temperature conditions of the molding process. The mold usually contains one or more inlets through which the reaction mixture is introduced. The mold may contain vents to allow gases to escape as the reaction mixture is injected. The mold is typically held in a press or other apparatus which allows it to be opened and closed, and which can apply pressure on the mold to keep it closed during the filling and curing operations. The mold or press is provided with means by which heat can be provided.

In a preferred embodiment of the present invention, the curable composition is applied to a reinforcing agent and cured in the presence of the reinforcing agent to form reinforced composites.

Reinforcement agents may be, for example, blended with the epoxy resin or the amine curing agent (or both), prior to mixing to obtain the curable compositions. Alternatively, the reinforcing agents may be added io the curable compostions at the same time as the epoxy resin and the amine curing agent are mixed, or afterward but prior to introducing the curable composition into the mold or applying the curable composition to a surface, e.g. by spraying the curable composition into a mold.

Suitable reinforcement agents are fibrous materials or non-fibrous materials.

Fibrous materials include glass, quartz, polyamide resins, boron, carbon and gel-spun polyethylene fibers.

Non-fibrous reinforcing agents include glass flakes, aramid particles, carbon black, carbon nanotubes, various clays such as montmorillonite, and other mineral fillers such as wollastonite, talc, mica, titanium dioxide, barium sulfate, calcium carbonate, calcium silicate, flint powder, carborundum, molybdenum silicate, sand, and the like.

Non fibrous reinforcing agents may also include conductive materials, such as aluminum and copper, and carbon black, carbon nanotubes, carbon fibers, graphite and the like.

The reinforcement agent can take any of several forms, such as a fiber preform, continuous fiber ravings, cut fibers or chopped fibers.

Preferably the reinforcement agent is in form of a fiber preform, i.e., a web or mat of fibers. The fiber preform can be made up of continuous filament mats, in which the continuous filaments are woven, entangled or adhered together to form a preform that approximates the size and shape of the finished composite article (or portion thereof that requires reinforcement). Alternatively, shorter fibers can be formed into a preform through entanglement or adhesive methods. Mats of continuous or shorter fibers can be stacked and pressed together to form preforms of various thicknesses, if required. Fiber preforms are typically placed into the mold prior to introducing the curable composition. The curable composition can be introduced into a closed mold that contains the preform, by injecting the curable composition into the mold, where the curable composition penetrates between the fibers in the preform and then cures to form a cured epoxy resin. Reaction injection molding andior resin transfer molding equipment is suitable in such cases. Alternatively, the preform can be deposited into an open mold, and the curable composition can be sprayed onto the preform and into the mold. After the mold is filled in this manner, the mold is closed and the curable composition is cured. In either approach, the mold and the preform are preferably heated prior to contacting them with the curable composition.

Short fibers can be used instead or in addition to a fiber preform. Short fibers (up to about 20 cm in length, preferably up to 5 cm in length, more preferably up to about 2 cm in length can be blended with the curable composition and injected into the mold together with the curable composition. Such short fibers may be, for example, blended with the epoxy resin or the amine curing agent (or both), prior to mixing to obtain the curable compositions. Alternatively, the short fibers may be added into the curable compostions at the same time as the epoxy resin and the amine curing agent are mixed, or afterward but prior to introducing the curable composition into the mold.

Short fibers can be sprayed into a mold. In such cases, the curable composition can also be sprayed into the mold, at the same time or after the short fibers are sprayed in. When the fibers and the curable composition are sprayed simultaneously, they can be mixed together prior to spraying. Alternatively, the fibers and the curable composition can be sprayed into the mold separately but simultaneously.

Various processes for the production of reinforced composites, which are well-known by a person skilled in the arts, may be used such as RTM, VARTM, RFI and SCRIMP. In these processes, a reinforcement agent in form of woven or matted fiber preform is inserted into a mold cavity. The mold is closed, and the resin is injected into the mold. The resin hardens in the mold to form a composite, and is then demolded.

Reinforced composites may also be produced by pultrusion processes.

Pultrusion processes use continuous fibers that are oriented parallel to each other, in the direction of extrusion. Pultrusion processes are operated in a manner analogous to molding processes, the main difference being that the hot reaction mixture is delivered into a resin bath rather than into a mold. The resin bath is a reservoir filled with the curable composition, through which the continuous fibers are pulled. Once the fibers are wetted with the hot reaction mixture, they are pulled through one or more dies, in which the fibers are consolidated and formed into the desired cross-sectional shape.

It has been found that the amine curing agent compositions of the present invention comprising a high content of linear TETA lead to cured epoxy resins having a higher glass transition temperature T_{g} as compared to commercially available prior art TETA mixtures containing linear TETA, DAEPIP, PEEDA and TAEA. The higher Tg broadens the temperature range in which cured epoxy resins can be applied. Mechanical properties of the epoxy resins severely decline as soon as T_{g} is exceeded.

In addition, curable compositions according to the present invention may be cured at higher temperatures, in particular according to a process according to US-A2008/0197526, which enables the fabrication of reinforced composites, especially for automotive and aerospace components.

The increase in T_{g} is not accompanied by an increase in curing time of the curable compositions as would have been expected due to due to the reduction of the content of catalytically active tertiary amines in comparison to “commercially available TETA”. It has been found that using amine curing agent compositions accordind the present invention significantly reduces the curing time as compared to prior art “commercially available TETA”. The reduced curing time leads to shorter cycle times, which is in general advantageous in the production of form parts, such as carbon fiber reinforced composites (CFK) small parts in the automotive industry where a high throughput is desired.

The increase in T_{g} is also not accompanied by a deterioration of the pot life and therefore the use amine curing agent compositions used in the curable compositions according to the present invention give rise to excellent processing properties and a high process stability. The increase of T_{g} does not detrimentally effect the mechanical properties characteristic for prior art “commercially available TETA”.

The amine curing agents used in the process of the present invention for the production of curable compositions and cured resins are particularly suited for applications in the field of automotive components and parts, wind turbines, filament wound pipe, printed circuits, aircraft/aerospace, ordnance, sports/recreation, fiber composites, construction and adhesives.

Cured epoxy resins based on curable compositions based on epoxy resins made from curable compositions containing LERs (Liquid Epoxy Resin) usually have excellent electrical properties, chemical resistance, heat resistance, and adhesion. Cured LERs generally provide good strength and hardness.

Cured epoxy resins based on curable compositions comprising LERs based on DGEBA are widely used in the coatings industry. The longer backbones generally give more distance between cross-links when cross-linked through the terminal epoxy groups, resulting in improved flexibility and toughness. Furthermore, the resins can also be cured through the multiple hydroxyl groups along the backbones using cross-linkers such as phenol-formaldehyde resoles or isocyanates to create different network structures and performance.

Cured epoxy resins based on curable compositions containing Novalac resins usually have a higher cross-linking density, leading to improved thermal and chemical resistance properties over bisphenol A epoxides. They are therefore often used in high temperatures applications such as aerospace composites. Filament wound pipe and storage tanks, liners for pumps and other chemical process equipment, corrosion resistant coatings are other typical applications, which take advantage of the high chemical resistance.

The amine composition of the present invention and/or “pure” or “purified” TETA may also advantaaeously be used for the production of reactive polyamide resins.

Therefore the present invention also refers to reactive polyamide resin, obtainable from the reaction of an amine composition according to claim I and/or triethyienetetramine of formula I having a purity of 98% by weight or more with dimer fatty acids.

Reactive polyamides are lower-molecular-weight (1,000-2,000·g/mol) products from the condensation of dimer fatty acid and one of the higher ethyieneamines (diethylenetriamine, triethylenetetramine and others). Reactive polyamides are used almost exclusively as curing agents in two-component epoxy systems for industrial and marine maintenance coatings, thermosetting adhesive systems, electronics encapsulation and flooring arouts and trowel coatings. Their amine groups provide reactive sites for cross-linking interactions with epoxy resin molecules.

Reactive polyamides are usually produced in a batch condensation process. The reactants (dimer fatty acid and the amine compositions according the present invention and/or “pure” or “purified” TETA) are generally heated heated to 150-250° C. By-product water is usually removed by vacuum distillation. The resulting polyamide is then removed and converted to forms suitable for shipping.

Dimer fatty acids are most frequently obtained by the polymerization of monocarboxylic acids containing ethyleneic unsaturation. The monocarboxylic unsaturated acids generally contain from about 16 to 26 carbon atoms and include, for example, oleic acid, linoleic acid, eleostearic acid and similar singly or doubly unsaturated acids. To obtain the preferred dimer acids 2 mols of the unsaturated monocarboxylic acid are reacted, i.e., dimerized. Oleic acid, linoleic acid and linolenic acid are generally used as unsaturated fatty acids. The dimer acids, obtained in this manner, can subsequently be hydrogenated.

Reactive poiyamide res ns obtained from the reaction of dimer fatty acids and amine compositions according to the invention and/or “pure” or “purified” TETA have a higher functionality compared to reactive polyamide resins obtained from conventional TETA. The higher functionality results in an increase of mechanical properties of the resulting systems. Surprisingly it has been found that reactive polyamide resins obtained from the reaction of dimer fatty acids and amine compositions according to the invention and/or “pure” or “purified” TETA have a higher content of imidazoline rings formed as a side product in the reaction of the carboxylic acid group of the dimer fatty acid and TETA of formula I. It is believed that imidazoline ring formation is concurrent with the improvement of intercoat adhesion

The invention is illustrated by the following examples.

### EXAMPLES

The composition of the amine curing agent compositions was analyzed by gas chromatography (column: Rtx-5 amine, 30 m, 0.32 mm, 1.50 μm; gas chromatograph: HP 5890 with auto sampler; injection temperature: 250° C.; detector temperature: 300° C.; temperature program: 60° C.—5 Min isothermal—15 ° C./Min—280° C.; internal standard: diethylenglykoldimethylether (DEGDME))

### Example 1

A reaction effluent comprising of following composition:

Lower boiling amines: 4% by weight (e.g. AEPIP, DETA, EDA, Methyl-EDA, Piperazine)

AEEA: 23% by weight

TETA of formula I: 24% by weight

Higher boiling amines: 49% by weight (e.g. diethanolamine (DEOA), tetraethylenepentamin (TEPA), N-[1-(2-piperazine-1-yl-ethyl)]-ethane-1,2-diamine (C8-PIP)) was obtained by the reaction of monoethanolamine (MEOA) and ammonia and subsequent sequential distillation.

This effluent was fed into the mid section of a distillation column operated at 50 mbar and a top temperature of 154° C. AEEA and the lower boiling amine fraction were removed at the top of the column and a mixture of higher boiling amines and TETA was removed at the bottom of the column. The bottom product of the first reaction column was fed into the middle of a second distillation column operated at 30 mbar and a temperature at the column top of 164° C. An amine composition was removed as a top stream.

The composition of the amine composition was as follows:

Linear TETA of formula I: 95.8% by weight

AEEA: 1.7% by weight

Tertiary amines derived from EDA (TADE): 3.3% by weight

### Example 2

100 g of Epilox® A18-00 epoxy resin (Epilox® A 18-00 is a low viscosity and solventiess bisphenol A epoxy resin produced by LEUNA-Harze GmbH) were mixed with 14 g of an amine curing agent composition consisting of the amine composition obtained in example 1.

The following studies were conducted on the resin mixture.

a) Determination of the onset temperature of the crosslinking reaction by DSC (differential scanning calorimetry)

The onset temperature of the crosslinking reaction was 62° C.

b) Pot life measurement

100 g of the resin mixture were placed in a cardboard beaker at room temperature. A data logger is used to measure the temperature of the sample as a function of time.

The latency of the resin mixture with pure linear TETA as hardener was longer than that of the comparative example (see below) at the beginning, but the mixture then cured to completion very rapidly.

c) Determination of the gel point by theological study

The activity of resin systems was determined by monitoring the progress of reaction using a rheometer. This involves plotting a variable known as the storage modulus against a variable known as the loss modulus. The point at which the two curves intersect is referred to as the gel point. The corresponding reaction time is known as the gel time, and constitutes a measure of the reactivity of the epoxy resin system.

A gel time of 8.3 minutes was found.

d) DSC is used to determine the glass transition temperature of the cured epoxy resin. Cured epoxy resins possess good mechanical properties when the service temperature is <the glass transition temperature. Above the glass transition temperature there is a dramatic deterioration in the mechanical properties of the epoxy resins.

The glass transition temperature was found to be 136° C.

### Example 3 (Comparative Example)

100 g of Epilox° A18-00 epoxy resin were mixed with 14 g of “commercially available TETA” from Akzo, containing about 69% by weight linear triethylenetetramine, about 6% by weight TAEA, about 15% by weight DAEPIP, and about 10% by weight PEEDA.

The studies as described above were conducted on the resin mixture.

a) The onset temperature of the crosslinking reaction was 58° C.

b) The latency time of the comparative resin mixture was shorter than that of the resin mixture of the inventive example.

c) The gel time was found to be 9.3 minutes.

d) The glass transition temperature Tg was found to be 115° C.

The glass transition temperature of the epoxy resin cured with the amine curing agent composition comprising the amine composition according to the present invention was approximately 21° C. higher than that of the comparative resin. Accordingly the resin of the inventive example can be used at significantly higher temperatures. The higher onset temperature of the crosslinking reaction and the longer latency time of the inventively cured epoxy resin are technically advantageous from a processing standpoint and offer additional safety, since the autocatalytic curing reaction does not beain until later.

The cure time (gel time) of the epoxy resin is shortened by approximately 15% over the comparative example through the use of pure linear TETA. This is accompanied by a shortening in the cycle times, with beneficial effects for investment costs in the case, for example, of high-volume manufacture of moldings, such as of small carbon fibre reinforced plastic (CRP) components in the automotive sector.

### Example 4

4.7 g of Raney-Cobalt and 40 g of tetrahydrofurane (THF) were charged to a 300 ml autoclave. The autoclave was heated to 120° C. and a hydrogen pressure of 100 bar was applied. In the course of 120 minutes, a mixture of 16 g of ethylenediaminediacetonitrile (EDON), 0.5 g of ethylenediaminomonoacetonitrile (EDMN), 1.3 g of biscyanomethylimidadzolidine (BCMI) and 100 g of THF was fed to the autoclave. The reaction mixture was stirred for another 60 minutes at 120° C. and a hydrogen pressure of 100 bar.

The reaction mixture was narrowed in under a water jet vacuum and the remaining residue was fractionated at 20 mbar. The fraction taken at a column head temperature of 150° C. had following composition: 96.5% by weigt of linear TETA, 3.1% by weigt of Me-TETA and 0.4% by weight of other organic components.

### Example 5

100 g of Epilox® A18-00 epoxy resin (Epilox® A 18-00 is a low viscosity and solventiess bisphenol A epoxy resin produced by LEUNA-Harze GmbH) were mixed with 14 g of an amine curing agent composition consisting of the amine composition obtained in a) example 1, b) example 4 or c) a commercial TETA mixture obtained from Huntsman containing about 69% by weight linear triethylenetetramine, about 6% by weight TAEA, about 15% by weight DAEPIP, and about 10% by weight PEEDA.

a) Initial viscosity:

The mixture of Epilox and the TETA composition was heated to 23° C. and poured into a cardboard beaker in order to measure the initial viscosity of the mixture. Following values were determined:

a) 2625 mPas for the TETA composition according to example 1;

b) 2485 mPas for the TETA composition according to example 3;

c) 2903 mPas for the commercial TETA composition.

b) Viscosity increase at 23° C.:

The development of the viscosity of the initial mixture obtained according to example 5a) was followed. The time at which the maximum value for the viscosity was obtained was:

a) 61 minutes for the TETA composition according to example 1;

b) 63 minutes for the TETA composition according to example 3;

c) 57 minutes for the commercial TETA composition.

The linear TETA compositions according to the present invention (a) and b)) possess a lower initial viscosity than the commercial TETA compositions. This is advantageous for the filling or construction of large mouldings or construction parts. The time until the maximum viscosity is reached is proportional to the latency time of the system. A longer latency is are technically advantageous from a processing standpoint and offer additional safety, since the autocatalytic curing reaction does not begin until later.

c) Determination of the onset temperature of the crosslinking reaction by DSC (differential scanning calorimetry)

The onset temperature of the crosslinking reaction was as follows:

a) 63° C. for the TETA composition according to example 1;

b) 64° C. for the TETA composition according to example 3;

c) 61° C. for the commercial TETA composition.

As stated above, the higher onset temperature of the crosslinking reaction are technically advantageous from a processing standpoint and offer additional safety.

d) Determination of the gel point by rheological study

The activity of resin systems was determined by monitoring the progress of reaction using a rheometer. This involves plotting a variable known as the storage modulus against a variable known as the loss modulus. The point at which the two curves intersect is referred to as the gel point. The corresponding reaction time is known as the gel time, and constitutes a measure of the reactivity of the epoxy resin system.

Following gel times were measured:

a) 8.6 minutes for the TETA composition according to example 1;

b) 8.3 minutes for the TETA composition according to example 3;

c) 9.3 minutes for the commercial TETA composition.

The cure time (gel time) of the epoxy resin using the linear TETA compositions according to the present invention is shortened by approximately 8 to 10% over the comparative example through the use of pure linear TETA. This is accompanied by a shortening in the cycle times, with beneficial effects for investment costs in the case, for example, of high-volume manufacture of moldings, such as of small carbon fibre reinforced plastic (CRP) components in the automotive sector.

e) DSC is used to determine the glass transition temperature of the cured epoxy resin. Cured epoxy resins possess good mechanical properties when the service temperature is <the glass transition temperature. Above the glass transition temperature there is a dramatic deterioration in the mechanical properties of the epoxy resins.

The glass transition temperatures were found to be:

a) 149° C. for the TETA composition according to example 1;

b) 147° C. for the TETA composition according to example 3;

c) 124° C. for the commercial TETA composition.

The glass transition temperature of the epoxy resin cured with the amine curing agent composition comprising the amine composition according to the present invention was (a) and b)) approximately moe than 20° C. higher than that of the comparative resin.

Accordingly the resin of the inventive example can be used at significantly higher temperatures.

1-15. (canceled)

16. An amine composition comprising from 85 to 98% by weight of triethylenetetramine (TETA) of formula I 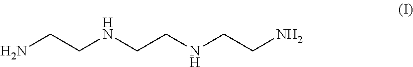
and 15% or less by weight of one or more amine compounds selected from the group consisting of tertiary amines derived from the condensation of ethylenediamine and methyl-substituted compounds derived from linear triethylenetetramine, based on the sum of the weight of TETA of formula I and the weight of the amine compounds selected from the group consisting of tertiary amines derived from the condensation of ethylenediamine and methyl-substituted compounds derived from linear triethylenetetramine.

17. A method for the production of the amine composition according to claim 16 by distillation of a reaction effluent obtained from the reaction of ethylene oxide with ammonia or by distillation of a reaction effluent obtained from the catalytic hydrogenation of ethylenediaminediacetonitrile.

18. An amine curing agent comprising the triethylenetetramine of formula I having a purity of 98% by weight or more and/or the amine composition according to claim 16.

19. An amine curing agent composition comprising an amine curing agent selected from the group consisting of the amine composition according to claim 16 and triethylenetetramine of formula I having a purity of 98% by weight or more, and one or more other amine curing agents.

20. The amine curing agent composition according to claim 19, wherein the content of the amine curing agent is selected from the group consisting of the amine composition according to claim 16 and triethylenetetramine of formula I having a purity of 98% by weight or more is 25% by weight or more, based on the weight of the amine curing agent composition.

21. The amine curing agent composition according to claim 20, wherein the content of the amine curing agent selected from the group consisting of the amine composition according to claim 16 and triethylenetetramine of formula I having a purity of 98% by weight or more is in the range of 25 to 99% by weight or more, based on the weight of the amine curing agent composition.

22. A curable composition comprising one or more epoxy resins and
the amine curing agent composition according to claim 19;
or at least one amine curing agent selected from the group consisting of the amine composition according to claim 16 and triethylenetetraniine of formula I having a purity of 98% by weight or more, wherein the weight ratio of triethylenetetraniine of formula I to amine compounds selected from the group consisting of tertiary amines derived from the condensation of ethylenediamine and methyl-substituted compounds derived from linear triethylenetetramine is 85:15 or more.

23. A method for the production of the curable composition according to claim 22 by mixing the amine curing agent composition according to claim 19
or at least one amine curing agent selected from the group consisting of the amine composition according to claim 16 and triethylenetetramine of formula I having a purity of 98% by weight or more,
with at least one epoxy resin.

24. A method for the production of a cured epoxy resin by transferring the curable compositions according to claim 22 to a mold or applying said curable compositions to a surface.

25. The method for the production of a cured epoxy resin according to claim 24, wherein the curable composition is applied to a reinforcing agent and cured in the presence of the reinforcing agent to form reinforced composites.

26. Cured epoxy resins obtainable by a method according to claim 24.

27. Epoxy resins comprising an amine composition comprising more than 85% by weight of triethylenetetramine of formula I or the amine curing agent composition according to claim 19 for the manufacture of epoxy resins.

28. A reactive polyamide resin obtained from the reaction of the amine composition according to claim 16 and/or triethylenetetramine of formula I having a purity of 98% by weight or more with dimer fatty acids.

29. A method of producing reactive polyamide resins by heating the amine composition according to claim 16 arid/or triethylenetetramine of formula I having a purity of 98% by weight or more with dimer fatty acids and removing the condensation product water by distillation.

30. Reactive polyamide resins produced from the amine composition according to claim 16 and/or triethylenetetramine of formula I having a purity of 98% by weight or more.
